(19) United States
(12) Patent Application Publication
(10) Pub. No.: US 2025/0160557 A1
(43) Pub. Date: May 22, 2025

(54) TRANSPARENT COOKER

(71) Applicant: J&R ELECTRONICS CO., LTD., Chongqing (CN)

(72) Inventor: Haibo DING, Chongqing (CN)

(21) Appl. No.: 18/955,082

(22) Filed: Nov. 21, 2024

(30) Foreign Application Priority Data
Nov. 22, 2023 (CN) 202323160996.6

(51) Int. Cl. A47J 27/00

(52) U.S. Cl. CPC A47J 27/004; A47J 27/002

(57) ABSTRACT

A transparent cooker includes an inner pot, a heating element disposed below the inner pot, and a housing disposed outside the inner pot. The housing is a transparent housing including a transparent lid, a transparent outer shell and a transparent bottom shell. The transparent lid is movably fitted with the transparent outer shell, the transparent outer shell is movably connected outside the inner pot, the transparent lid and the transparent outer shell form a heat preservation chamber outside the inner pot, and the transparent bottom shell is movably connected below the heating element.

### CROSS REFERENCE TO RELATED APPLICATIONS

The present application claims priority from Chinese Application No. CN 202323160996.6 filed on Nov. 22, 2023, all of which are hereby incorporated herein by reference.

### TECHNICAL FIELD

The present disclosure relates to the field of cookers, more specifically, to a transparent cooker.

### BACKGROUND

As a common electrical appliance in daily life, the cooker has a high frequency of use due to diversity of its cooking methods.

However, existing cookers are mostly applicable for indoor use, and mainly in a constructure including a single-piece plastic shell enclosing a metal inner pot, the plastic shell usually has a volume increasing with capacity of the inner pot. With such configuration, when used outdoors, the cooker needs to be packed integrally. What's more, smaller cookers would be brought at the price of less capacity of the inner pot, making it impossible to balance portability and larger capacity. Additionally, the opaque plastic shell allows the user not to observe cooking status of the inner pot and electric safety status of the cooker during operation.

Therefore, the existing cooks have disadvantages of occupying large space when carried for outdoor use due to heat preservation chamber of the cooker being non-disassemble into several assembly units; unable to maintain effective heat preservation in low-temperature outdoor environment due to remarkably reduced heat preservation capability thereof when separated from the heat source; and inadequate security caused by incomplete cleaning of the components due to invisibility of the heat preservation chamber and thus growth of bacteria under long-term accumulation of overflow liquid.

### SUMMARY

The present disclosure therefore seeks to provide a solution to the before-mentioned problems and provide an improved cooker which is free from the aforesaid drawbacks of the prior art.

According to the present disclosure, a transparent cooker is provided, which includes an inner pot, a heating element, and a housing. The heating element is disposed below the inner pot and the housing is disposed outside the inner pot. The housing is a transparent housing including a transparent lid, a transparent outer shell, and a transparent bottom shell. The transparent lid is movably fitted with the transparent outer shell, and the transparent outer shell is movably connected outside the inner pot. The transparent lid and the transparent outer shell form a heat preservation chamber outside the inner pot, and the transparent bottom shell is movably connected below the heating element.

The present disclosure enables disassembling the cooker into a plurality of small-sized assembly units with the detachable configuration of the removable transparent housing, the inner pot and the heating element, thereby improving portability of the cooker and expanding its application scenarios. Furthermore, the transparent housing allows visualization of the heat preservation chamber, making it convenient to timely clean up the inner pot overflow that is residually gathered between the various assembly units, which enhances hygiene and safety of use. In addition, the glass heat preservation chamber formed by the transparent lid and the transparent outer shell prolongs heat preservation time of the cooker, so that it can still be kept warm for a long time when used outdoors away from the heat source, thereby improving user experience.

Particularly, the transparent outer shell includes a transparent cylindrical body and a transparent convex rim according to an advantageous embodiment of the present disclosure, the transparent convex rim is disposed above the transparent cylindrical body, the bottom edge of the transparent cylindrical body is flushed with the bottom edge of the inner pot, and the transparent convex rim has an outwardly extending portion extending outwardly in a vertical direction and a horizontal portion extending inwardly in a horizontal direction, the outwardly extending portion the horizontal portion form a lower back-flow zone with the inner pot, while the horizontal portion forms an upper back-flow zone with the transparent lid.

The upper back-flow zone enables movement and collision of the heated vapor flowing upwardly from the inner pot along the inner edge of the transparent lid, resulting in gathering of the rising vapor in the upper back-flow zone. In addition, the lower back-flow zone can prevent the heated vapor from flowing directly back to the transparent lid after heat exchange with the heat preservation chamber, thereby prolonging gathering of the heated vapor in the lower back-flow zone.

According to an advantageous embodiment, a snap-fitting part is provided at the connection of the outwardly extending portion and the horizontal portion to enable movable connection with the transparent lid, and the inner pot has an outer extension opening, with the sum of the lengths of the horizontal portion and the outer extension opening greater than the maximum width of the transparent convex rim, and the height difference between the horizontal portion and the outer extension opening less than the minimum width of the transparent convex rim.

With such configuration, the snap-fitting part facilitates sealing connection and disassembly of the transparent lid and the transparent outer shell. The outwardly extending portion enables upper and lower staggered arrangement of the horizontal portion with the outer extension opening, guiding the heated vapor to flow in an S-shape path between the upper back-flow zone and the lower back-flow zone, thereby prolonging retention time of the heated vapor and thus enhancing heat preservation performance of the heat preservation chamber. In addition, the height difference between the horizontal portion and the outer extension opening can reduce upward movement of the heated vapor, thereby strengthening heat preservation performance of the heat preservation chamber.

According to an advantageous embodiment of the present disclosure, the transparent lid particularly includes an upper lid portion and a vertical portion. The vertical portion is disposed below the upper lid portion. The upper lid portion extends outwardly and obliquely in a vertical direction, and the outer elevation of the vertical portion is aligned with the outer elevation of the transparent convex rim.

The inclined upper lid portion enables the heated vapor to condense into droplets along the inclined outwardly extending upper lid portion and concentrate at the edge instead of directly dripping into the inner pot, thereby preventing adverse effects on the steaming flavor of the food in the inner pot. The aligned outer elevations of the vertical portion with the transparent convex rim make the volume of the cooker more regular and easier to pack and carry in a box.

Furthermore, the transparent lid is further provided with vapor holes and a flow-collecting recess. The vapor holes are uniformly distributed, and the flow-collecting recess is disposed in the center of the transparent lid for collecting liquid droplets formed by overflow liquid or exhaust vapor from the vapor holes in the inner pot.

According to the present disclosure, the uniformly distributed vapor holes equalize the micro-pressure formed by the heated vapor in the transparent lid, making the heating of the inner pot in the transparent lid and the transparent outer shell more uniform. The flow-collecting recess facilitates gathering excess overflow liquid or liquid droplets, thereby facilitating cleaning of the cooker, and thus ensuring the cooker remains hygienic and safe for use.

According to another embodiment of the present disclosure, the transparent bottom shell has an annular wall sleeved below the heating element, with the ratio of the height of the annular wall in the vertical direction to the height of the heating element in the vertical direction ranges from 1.1 to 2.1.

With the height of the annular wall greater than the height of the heating element, it makes the heating element not in direct contact with the ground, thereby avoiding direct heat loss. Additionally, the thermal conductivity of the inner pot disposed above the heating element is greater than the thermal conductivity of the air below the heating element, which greatly improves efficiency of thermal conductivity transferred from the heating element to the inner pot.

According to the present disclosure, the cooker may further include a deflector member. The deflector member is sleeved to the inner wall of the transparent outer shell, and extends downwardly and obliquely to form a flared curved surface ring. The outwardly expanded bottom edge of the curved surface ring is movably connected to the inner wall of the transparent outer shell.

The deflector member in the present disclosure can divert the overflow liquid from the inner pot. The flared curved surface ring facilitates isolating the overflow liquid from the heating element, avoiding uneven heat conduction between the inner pot and the heating element. In addition, the removable connection between the outwardly expanding bottom edge of the curved surface ring and the inner wall of the transparent outer shell can facilitate easy cleaning of the overflow liquid after dismantling the transparent outer shell, thereby preventing growth of bacteria.

Furthermore, the deflector member further includes a recessed portion for holding the inner pot, with the bottom edge of the recessed portion in contact with the heating element.

Supported by the recessed portion the inner pot can also be in direct contact with the heating element, which limits the contact area and contact position between the inner pot and the heating element, resulting in more uniform heating of the inner pot.

According to another embodiment of the present invention, the heating element has a convex ring which is convexly disposed on a rounded edge of the heating element, with the upper part of the convex ring sealingly connected to the transparent outer shell, the lower part of the convex ring sealingly connected to the transparent bottom shell, and the outer elevation of the convex ring flushed with the outer elevations of the transparent outer shell and the transparent bottom shell.

Configuration of the convex ring can facilitate convenient assembly of the transparent outer shell with the heating element, and convenient assembly of the transparent bottom shell with the heating element. The flush arrangement of the convex ring, the transparent outer shell and the transparent bottom shell further facilitates convenient packaging of a plurality of assembly units.

The transparent cooker may further include a carrying member. The carrying member is provided with a display screen and a built-in controller and configured for lifting the transparent lid and controlling the start-stop operation of the transparent cooker.

With configuration of the display screen and the built-in controller, it can achieve human-machine interaction, thus enabling control over the start-stop operation and other steaming functions of the cooker. The transparent lid can be opened and closed by directly grasping the carrying member.

Compared with the prior art, the beneficial effects of the present disclosure can be obtained.

The removable design of the transparent housing, the inner pot and the heating element enable disassembling the cooker into a plurality of small-sized assembling units, thereby improving portability of the cooker and expanding its application scenarios. The transparent housing enables visualization of the heat preservation chamber of the cooker, which facilitates timely cleaning of residual inner pot overflow gathered between the assembling units, thereby improving hygiene and safety of use. The glass heat preservation chamber formed by the transparent lid and the transparent outer shell prolongs heat preservation time of the cooker, enabling the cooker to remain warm for a long time when used outdoors away from the heat source, thus improving user experience. The gap between the transparent bottom shell and the heating element improves efficiency of heat conduction transferred from the heating element to the inner pot.

### BRIEF DESCRIPTION OF THE DRAWINGS

FIG. 1 shows an exploded structure view of a cooker according to an embodiment of the present disclosure;

FIG. 2 shows a sectional view of the cooker according to an embodiment of the present disclosure; and

FIG. 3 shows a schematic view of a deflector member of the cooker according to an embodiment of the present disclosure.

### DETAILED DESCRIPTION OF THE PREFERRED EMBODIMENTS

The accompanying drawings of the present disclosure are for exemplary illustration only and are not to be construed as a limitation of the present disclosure. In order to better illustrate the following embodiments, certain parts of the accompanying drawings may be omitted, enlarged or reduced, and do not represent the actual size of the product. It should be understandable to a person skilled in the art that certain well-known structures and their descriptions in the accompanying drawings may be omitted.

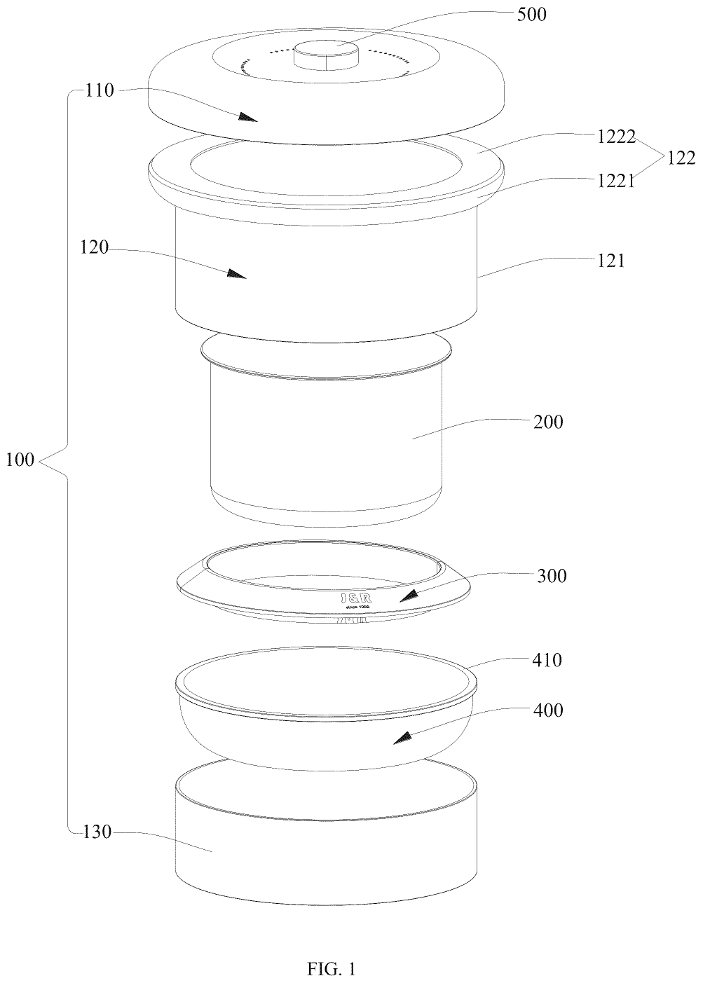

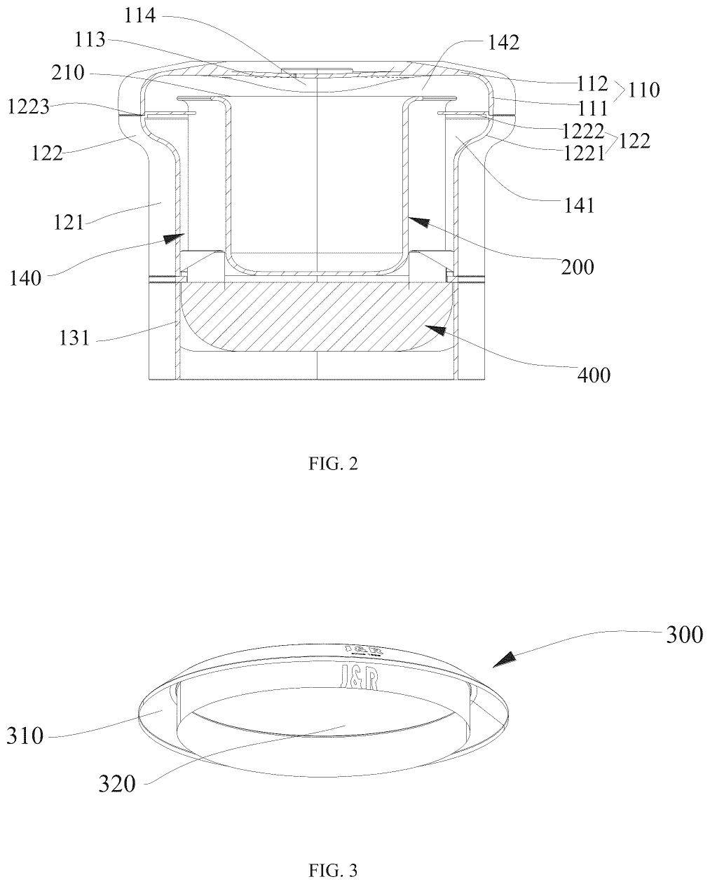

FIG. 1 provides a transparent cooker according to an embodiment of the present invention, including an inner pot 200, a heating element 400, and a housing 100. The heating element 400 is disposed below the inner pot 200 and the housing 100 is disposed outside of the inner pot 200. The housing 100 is a transparent housing including a transparent lid 110, a transparent outer shell 120, and a transparent bottom shell 130. The transparent lid 110 is movably fitted with the transparent outer shell 120, and the transparent outer shell 120 is movably connected outside the inner pot 200, with the transparent lid 110 and the transparent outer shell 120 forming a heat preservation chamber 140 outside the inner pot 200 (shown in FIG. 2), while the transparent bottom shell 130 is movably connected below the heating element 400.

In this embodiment, the inner pot 200 is made of metal or stainless steel, the heating element 400 is made of heat conducting material, and the housing 100 is made of insulating glass. During heating of the inner pot 200 by the heating element 400, one part of the heat energy is transferred through the inner pot 200 to the food in the inner pot 200, while another part of the heat energy is transferred to the heat preservation chamber 140 formed on the outside of the inner pot 200 and enclosed by the transparent lid 110 and the transparent outer shell 120. The heat in the heat preservation chamber 140 circulates and continuously exchanges heat with the outer wall of the inner pot 200 to reduce heat loss from the inner pot 200, thereby improving heat preservation capability. In addition, as components of the cooker including the inner pot 200, the heating element 400, the transparent lid 110, the transparent outer shell 120, and the transparent bottom shell 130 can be disassembled into respective assembly units, size for package is significantly reduced, resulting in easy to pack and carry, especially for outdoor use.

In combination with FIG. 2, the transparent outer shell 120 includes a transparent cylindrical body 121 and a transparent convex rim 122, with the transparent convex rim 122 disposed above the transparent cylindrical body 121, and the bottom edge of the transparent cylindrical body 121 being flush withed the bottom edge of the inner pot 200. The transparent convex rim 122 particularly includes an outwardly extending portion 1221 that is outwardly extending in the vertical direction and a horizontal portion 1222 that is inwardly extending in the horizontal direction. The outwardly extending portion 1221 and the horizontal portion 1222 form a lower back-flow zone 141 together with the inner pot 200, while the horizontal portion 1222 and the transparent lid 110 forms an upper back-flow zone 142 together.

According to the present embodiment, the transparent cylindrical body 121 is in form of a glass cylindrical body, with the bottom edge of the transparent cylindrical body 121 being flushed with the bottom edge of the inner pot 200, and the height of the transparent cylindrical body 121 being close to ⅔ of the height of the inner pot 200, such that heat absorbed by the inner pot 200 from the heating element 400 is enclosed in the heat preservation chamber 140 without overflowing.

In this embodiment, to form better heat preservation effect between the transparent convex rim 122 and the transparent lid 110, the horizontal portion 1222 divides the heat preservation chamber 140 into the upper back-flow zone 142 formed by the horizontal portion 1222 and the transparent lid 110 and the lower back-flow zone 141 formed by the horizontal portion 1222, the outwardly extending portion 1221 and the inner pot 200. With such configuration, vapor generated by the inner pot 200 due to heating rises and collides with the transparent lid 110, then moves downward along the transparent lid 110 to the upper back-flow zone 142, where the vapor collides again and moves upwardly above the inner pot 200, then further mix with subsequently generated vapor, thus forming effective heat preservation between the transparent convex rim 122 and the transparent lid 110. In addition, since the horizontal portion 1222 forms a semi-closed lower back-flow zone 141 above the opening at the maximum width of the outwardly extending portion 1221, the heat in the heat preservation chamber 140 will not escape along the opening at the maximum width of the outwardly extending portion 1221. Additionally, the heat in the heat preservation chamber 140 is repeatedly circulated in the lower back-flow zone 141, thereby enhancing heat preservation effect between the transparent convex rim 122 and the transparent cylindrical body 121.

In the present embodiment, not only is an improved heat preservation effect formed between the transparent convex rim 122, transparent cylindrical body 121, transparent lid 110 and the inner pot 200, but also a good experience is brought to the user, enabling the user to always observe cooking state as well as heating state in the inner pot 200, thereby preventing safety hazards such as overflow accumulation or overheating of the inner pot 200.

A snap-fitting part 223 is provided at the connection between the outwardly extending portion 1221 and the horizontal portion 1222 to enable movable connection with the transparent lid 110. the inner pot 200 has an outer extension opening 210, the sum of the lengths of the horizontal portion 1222 and the outer extension opening 210 is greater than the maximum width of the transparent convex rim 122, and the height difference between the horizontal portion 1222 and the outer extension opening 210 is less than the minimum width of the transparent convex rim 122.

In this embodiment, the transparent lid 110 is provided with a tab matching the snap-fitting part 223 whereby the transparent lid 110 forms an enclosure with the transparent outer shell 120 when closed. The outer extension opening of the inner pot 200 is formed by the outer wall of the inner pot 200 extending upwardly, forming a roughly 90 degrees angle with the outer wall of the inner pot 200. In order to prevent heat loss from the heat preservation chamber 140 along the horizontal direction, the horizontal partition is required to be larger than the maximum width of the transparent convex rim 122. The horizontal portion is disposed above the maximum width of the transparent convex rim 122 to form a first partition layer, while the outer extension opening extends horizontally beyond the end of the horizontal portion and is disposed above the horizontal portion to form a second partition layer. Further to prevent heat loss from the heat preservation chamber 140 along the vertical direction, a vertical sealing dimension is designed to be smaller than the minimum width of the transparent convex rim 122. The outer extension opening is disposed above the horizontal portion and forms a height difference therebetween, such height difference serving as the vertical sealing dimension.

The transparent lid 110 according to the present invention includes an upper lid portion 111 and a vertical portion 112, with the vertical portion 112 disposed below the upper lid portion 111, the upper lid portion 111 extending outwardly and obliquely in the vertical direction, and the outer elevation of the vertical portion 112 aligned with the outer elevation of the transparent convex rim 122.

In the present embodiment, as FIG. 2 shown, the upper lid portion 111 is an inclined downward-facing lid, allowing the vapor from the inner pot 200 condensed into liquid droplets to flow along the inclined surface toward the vertical portion of the transparent lid 110, thus preventing the droplets from falling back into the inner pot 200 and affecting the cooking quality in the inner pot 200. The vertical portion 112 has an arcuate connection with the upper lid portion 111, which not only prevents the buildup of liquid droplets at the connection but also enhance aesthetically pleasing. With the outer elevation of the vertical portion aligned with the outer elevation of the transparent convex rim 122, it not only prevents heat loss in the upper back-flow zone 142 and the lower back-flow zone 141, but also enhances aesthetically pleasing.

The transparent lid 110 further includes vapor holes 113 and flow-collecting recess 114. The vapor holes 113 are evenly distributed. The flow-collecting recess 114 is disposed in the center of the transparent lid 110 for collecting overflow liquid from the inner pot 200 or liquid droplets formed by exhaust vapor from the vapor holes 113.

In this embodiment, the vapor holes 113 are uniformly distributed on the upper lid portion and directly above the opening of the inner pot 200, which facilitates discharge of excess vapor generated during the heating process of the inner pot 200. In addition, the flow-collecting recess 114 is disposed at the center of the transparent lid 110 for collecting overflow liquid discharged with the vapor during the heating process of the inner pot 200, which facilitates the centralized cleaning of the overflow liquid, thereby maintaining the transparent cooker in a safe and hygienic condition, and also improving aesthetic and ornamental appearance.

According to the present disclosure, the transparent bottom shell 130 has an annular wall 131. The annular wall 131 is sleeved below the heating element 400, with the ratio of the height of the annular wall 131 in the vertical direction to the height of the heating element 400 in the vertical direction ranging from 1.1 to 2.1.

In the present embodiment, as FIG. 2 shown, the heating element 400 has a hemispherical shape with both upper and lower planar surfaces, the upper edge of the annular wall 131 is connected to the edge of the upper plane of the heating element 400, while the height of the annular wall 131 is greater than the height of the heating element 400, thereby realizing isolation and heat preservation by forming an air layer between the annular wall 131 and the ground on which the transparent cooker is disposed. This prevents the transparent cooker from transferring heat generated by the heating element 400 to the ground in large quantities, thus preventing the efficiency of the inner pot 200 in absorbing heat from being greatly reduced.

Referring back to FIG. 1, the cooker further includes a deflector member 300. The deflector member 300 is sleeved with the inner wall of the transparent outer shell 120. As shown in FIG. 3, the deflector member 300 extends downwardly and obliquely to form a flared curved surface ring 310, with the externally expanded bottom edge of the curved surface ring 310 movably connected to the inner wall of the transparent outer shell 120.

In this embodiment, the deflector member 300 has a flared shape, guiding the overflow liquid from the inner pot 200 toward the transparent outer shell 120 via the downwardly inclined curved surface, thereby avoiding the potential safety hazard caused by the reduction in electrical safety due to contact between the overflow liquid and the heating element 400. The externally expanded bottom edge of the curved surface ring 310 is in contact with the inner wall of the transparent outer shell 120, so that when cleaning up the overflow liquid, it is only required the user to slightly lift the transparent outer shell 120, the overflow liquid can be wiped away.

As shown in FIG. 3, the deflector member 300 further includes a recessed portion 320 for holding the inner pot 200, with the bottom edge of the recessed portion 320 being in contact with the heating element 400.

In this embodiment, the deflector member 300 is removable. For placing the inner pot 200 onto the heating element 400, it is allowed that the deflector member 300 is firstly positioned on the heating element 400, followed by the inner pot 200 being placed on the recessed portion 320 of the deflector member 300, which can ensure even heating of the inner pot 200.

Referring back to FIG. 1, the heating element 400 includes a convex ring 410. The convex ring 410 is convexly disposed on a rounded edge of the heating element 400, with the upper part of the convex ring 410 being sealingly connected to the transparent outer shell 120, the lower part of the convex ring 410 being sealingly connected to the transparent bottom shell 130, and the outer elevation of the convex ring 410 flushed with the outer elevations of the transparent outer shell 120 and the transparent bottom shell 130.

In this embodiment, the convex ring 410 is disposed on the upper edge of the heating element 400, the convex ring 410 is connected with the transparent outer shell 120 at the top, and the convex ring 410 is connected with the transparent bottom shell 130 at the bottom. The convex ring 410 is provided with a rubber ring on both the top and the bottom, thereby maintaining sealing without leakage of liquid when the transparent outer shell 120 is arranged on the convex ring 410, and enabling the transparent bottom shell 130 to remain sealing against heat loss when arranged below the convex ring 410.

Further referring to FIG. 1, the transparent cooker further includes a carrying member 500. The carrying member 500 is provided with a display screen and a built-in controller, which is configured for lifting the transparent lid 110 and controlling the start-stop operations of the transparent cooker.

The carrying member 500 may be fixed on the transparent lid 110 or may be magnetically or otherwise detachably attached to the transparent lid 110. In this embodiment, the carrying member 500 is fixed and used as a handle when lifting the transparent lid 110. Because of the built-in controller and display screen in the transparent lid 110, the transparent cooker can be activated through pressing an operation button on the carrying member 500.

It is evident that the above embodiments of the present disclosure are merely examples to clearly illustrate the technical solutions of the present disclosure, and are not intended to limit the specific embodiments of the present disclosure. Any modifications, equivalent substitutions, or improvements made within the spirit and principles of the claims of the present disclosure shall be included in the scope of protection of the claims of the present disclosure.

What is claimed is:

1. A transparent cooker comprising an inner pot;
a heating element, which is disposed below the inner pot; and
a housing, which is disposed outside the inner pot,
wherein the housing is a transparent housing comprising a transparent lid, a transparent outer shell and a transparent bottom shell, the transparent lid being movably fitted with the transparent outer shell, and the transparent outer shell being movably connected outside the inner pot, wherein the transparent lid and the transparent outer shell form a heat preservation chamber outside the inner pot, and the transparent bottom shell is movably connected below the heating element.

2. The transparent cooker according to claim 1, wherein the transparent outer shell comprises a transparent cylindrical body and a transparent convex rim disposed above the transparent cylindrical body, with a bottom edge of the transparent cylindrical body flushed with a bottom edge of the inner pot; and wherein the transparent convex rim comprises an outwardly extending portion extending outwardly in a vertical direction and a horizontal portion extending inwardly in a horizontal direction, the outwardly extending portion and the horizontal portion form a lower back-flow zone with the inner pot, and the horizontal portion forms an upper back-flow zone with the transparent lid.

3. The transparent cooker according to claim 2, wherein a bottom edge of the transparent cylindrical body is flushed with a bottom edge of the inner pot, and a height of the transparent cylindrical body is substantially ⅔ of a height of the inner pot.

4. The transparent cooker according to claim 2, wherein a connection between the outwardly extending portion and the horizontal portion is provided with a snap-fitting part for movable connection with the transparent lid, and the inner pot has an outer extension opening, and wherein a sum of lengths of the horizontal portion and the outer extension opening is greater than a maximum width of the transparent convex rim, and a height difference between the horizontal portion and the outer extension opening is less than a minimum width of the transparent convex rim.

5. The transparent cooker according to claim 4, wherein the horizontal portion is disposed above the maximum width of the transparent convex rim to form a first partition layer, and the outer extension opening extends horizontally beyond an outer end of the horizontal portion and is disposed above the horizontal portion to form a second partition layer, the first partition layer and second partition layer serve for preventing heat loss from the heat preservation chamber along the horizontal direction.

6. The transparent cooker according to claim 1, wherein the transparent lid comprises an upper lid portion and a vertical portion disposed below the upper lid portion, and wherein the upper lid portion extends outwardly and obliquely in a vertical direction, and an outer elevation of the vertical portion is aligned with an outer elevation of the transparent convex rim.

7. The transparent cooker according to claim 1, wherein the transparent lid comprises uniformly distributed vapor holes, and a flow-collecting recess disposed in a center of the transparent lid and configured for collecting overflow liquid from the inner pot or droplets formed by exhaust vapor from the vapor holes.

8. The transparent cooker according to claim 1, wherein the transparent bottom shell has an annular wall sleeved below the heating element, with a ratio of a height of the annular wall in a vertical direction to a height of the heating element in the vertical direction ranges from 1.1 to 2.1.

9. The transparent cooker according to claim 1, further comprising a deflector member, which is sleeved to an inner wall of the transparent outer shell and extends downwardly and obliquely to form a flared curved surface ring, with an externally expanded bottom edge of the curved surface ring movably connected to an inner wall of the transparent outer shell.

10. The transparent cooker according to claim 7, wherein the deflector member further comprises a recessed portion for holding the inner pot, with a bottom edge of the recessed portion in contact with the heating element.

11. The transparent cooker according to claim 1, wherein the heating element comprises a convex ring which is convexly disposed on a rounded edge of the heating element, an upper part of the convex ring is sealingly connected to the transparent outer shell, a lower part of the convex ring is sealingly connected to the transparent bottom shell, and an outer elevation of the convex ring is flushed with outer elevations of the transparent outer shell and the transparent bottom shell.

12. The transparent cooker according to claim 1, further comprising a carrying member provided with a display screen and a built-in controller, which is configured for lifting the transparent lid and controlling operation of the transparent cooker.
